(19) United States
(12) Patent Application Publication
(10) Pub. No.: US 2021/0243825 A1
(43) Pub. Date: Aug. 5, 2021

(54) COMMUNICATION APPARATUS, CONTROL METHOD OF COMMUNICATION APPARATUS, AND NON-TRANSITORY COMPUTER-READABLE STORAGE MEDIUM

(71) Applicant: CANON KABUSHIKI KAISHA, Tokyo (JP)

(72) Inventor: Tomoyuki Takada, Tokyo (JP)

(21) Appl. No.: 17/235,973

(22) Filed: Apr. 21, 2021

Related U.S. Application Data
(63) Continuation of application No. PCT/JP2019/046995, filed on Dec. 2, 2019.

(30) Foreign Application Priority Data
Dec. 28, 2018 (JP) 2018-248367

(51) Int. Cl. H04W 76/12; H04L 12/24; H04W 76/32; H04W 12/50

(52) U.S. Cl. CPC H04W 76/12; H04L 41/0806; H04W 12/50; H04W 76/32; H04L 41/0672

(57) ABSTRACT

A communication apparatus functioning as an enrollee defined by a Device Provisioning Protocol (DPP) standard requests a communication parameter to be used by the communication apparatus to participate in a network formed by an access point from another communication apparatus functioning as a configurator defined by the DPP standard, receives the communication parameter from the other communication apparatus in response to the request, attempts to participate in the network using the communication parameter, and transmits an attempt result of the participation in the network to the other communication apparatus.

### CROSS-REFERENCE TO RELATED APPLICATIONS

This application is a Continuation of International Patent Application No. PCT/JP2019/046995, filed Dec. 2, 2019, which claims the benefit of Japanese Patent Application No. 2018-248367, filed Dec. 28, 2018, both of which are hereby incorporated by reference herein in their entirety.

### BACKGROUND OF THE INVENTION

### Field of the Invention

The present invention relates to a communication technique by wireless communication.

### Background Art

To participate in a wireless LAN (Local Area Network), various communication parameters need to be set. As a technique of facilitating setting of such communication parameters, a DPP (Device Provisioning Protocol) standard has been formulated. In the DPP, a communication apparatus functioning as a configurator transmits (provides) communication parameters such as a connector to a communication apparatus functioning as an enrollee (PTL 1). Upon receiving the communication parameters, the communication apparatus functioning as an enrollee attempts to participate in a wireless LAN formed by an access point.

### CITATION LIST

### Patent Literature

PTL 1: Japanese Patent Laid-Open No. 2018-42057

For example, assume a case in which the communication apparatus functioning as a configurator is a smartphone, and the communication apparatus functioning as an enrollee is a printer. In this case, the smartphone transmits the communication parameters to the printer in accordance with, for example, an operation by a user. The printer that has received the communication parameters attempts to participate in the wireless LAN. At this time, it is difficult for the user of the smartphone to know whether the printer has succeeded in participating in the wireless LAN. Also, it is therefore difficult for the user of the smartphone to confirm whether transmission of the communication parameter to the printer is completed.

In consideration of the above-described problem, the present disclosure provides a technique of notifying an apparatus on a communication parameter providing side of a situation of an attempt in participating in a network by an apparatus on a communication parameter receiving side.

### SUMMARY OF THE INVENTION

According to one aspect of the present invention, there is provided a communication apparatus functioning as an enrollee defined by a Device Provisioning Protocol (DPP) standard, the apparatus comprising: a request unit configured to request a communication parameter to be used by the communication apparatus to participate in a network formed by an access point from another communication apparatus functioning as a configurator defined by the DPP standard, a reception unit configured to receive the communication parameter from the other communication apparatus in response to the request; a participation unit configured to attempt to participate in the network using the communication parameter; and a transmission unit configured to transmit an attempt result of the participation in the network by the participation unit to the other communication apparatus.

According to another aspect of the present invention, there is provided a communication apparatus functioning as a configurator defined by a Device Provisioning Protocol (DPP) standard, the apparatus comprising: a transmission unit configured to transmit, in response to a request, from another communication apparatus functioning as an enrollee defined by the DPP standard, for a communication parameter to be used by the other communication apparatus to participate in a network formed by an access point, the communication parameter to the other communication apparatus; and a reception unit configured to receive, from the other communication apparatus, an attempt result of the participation in the network by the other communication apparatus using the communication parameter.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram showing the schematic arrangement of a communication system 10;

FIG. 2A is a block diagram showing an example of the hardware arrangement of a smartphone 100;

FIG. 2B is a block diagram showing an example of the functional arrangement of the smartphone 100;

FIG. 3A is a block diagram showing an example of the hardware arrangement of a printer 101:

FIG. 3B is a block diagram showing an example of the functional arrangement of the printer 101:

FIG. 4 is a flowchart of processing of the smartphone 100 according to the first embodiment;

FIG. 5 is a view showing an example of a screen configured to cause a user to select one arbitrary access point from a plurality of access points;

FIG. 6 is a view showing an example of a screen including a message that notifies a user that participation in a wireless LAN has succeeded;

FIG. 7 is a view showing an example of a screen including a message that notifies a user that participation in a wireless LAN has failed;

FIG. 8 is a flowchart of processing of the printer 101 according to the first embodiment;

FIG. 9A is a flowchart of processing of a smartphone 100 according to the second embodiment;

FIG. 9B is a flowchart of processing of the smartphone 100 according to the second embodiment;

FIG. 10A is a flowchart of processing of a printer 101 according to the second embodiment; and

FIG. 10B is a flowchart of processing of the printer 101 according to the second embodiment.

### DESCRIPTION OF THE EMBODIMENTS

The present invention will now be described in detail based on an example of embodiments with reference to the accompanying drawings. Note that the arrangement shown in the following embodiments is merely an example, and the present invention is not limited to the illustrated arrangement.

### First Embodiment

(System Arrangement)

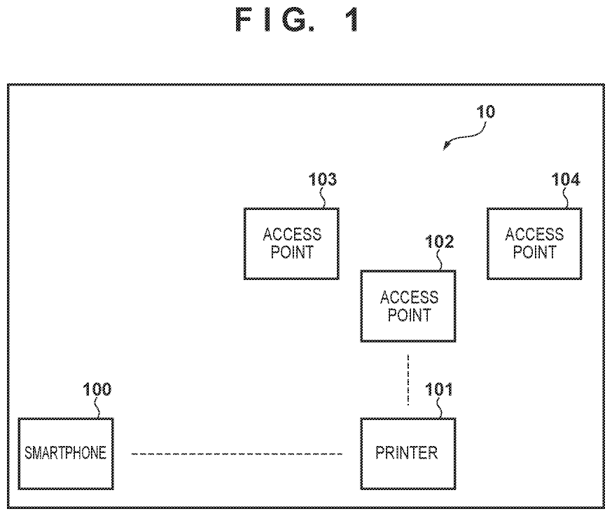

FIG. 1 shows the schematic arrangement of a communication system 10 according to the first embodiment. The communication system 10 is formed by a smartphone 100, a printer 101, and access points 102 to 104. The smartphone 100 functions as a configurator of DPP, and the printer 101 functions as an enrollee of DPP. Each of the access points 102 to 104 is an access point of a wireless LAN complying with the IEEE802.11 series standard. Note that the smartphone 100, the printer 101, and the access points 102 to 104 may be communication apparatuses of other types such as a portable telephone, a digital camera, and a multi-function peripheral. The communication system 10 shown in FIG. 1 includes three access points. However, this is merely an example, and four or more access points may be included.

(Arrangement of Smartphone 100)

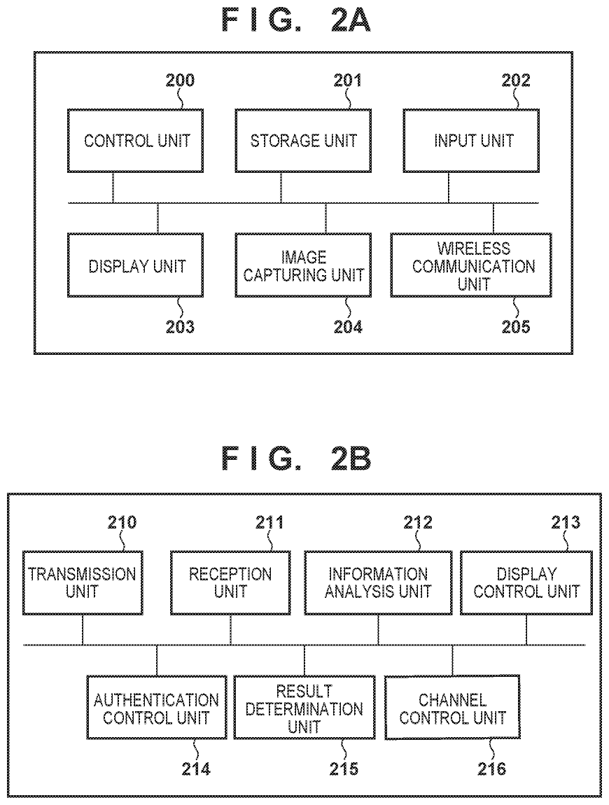

FIGS. 2A and 2B show the arrangement of the smartphone 100. FIG. 2A shows an example of the hardware arrangement of the smartphone 100, and FIG. 2B shows an example of the functional arrangement of the smartphone 100. The hardware arrangement of the smartphone 100 will be described first. Referring to FIG. 2A, a control unit 200 reads out a program stored in a storage unit 201 and executes it, thereby controlling each unit. The control unit 200 is formed by, for example, one or more CPUs (Central Processing Units) or one or more micro processing units. The storage unit 201 stores programs to be executed by the control unit 200, and information and the like associated with various kinds of settings used when the programs are executed. The storage unit 201 is also used to temporarily store information when the control unit 200 executes a program. The storage unit 201 is formed by, for example, at least one of a RAM (Random Access Memory), a ROM (Read Only Memory), a flash memory, and a hard disk.

An input unit 202 accepts an operation/input from the user, and transmits information corresponding to the operation/input to the units. The input unit 202 is formed by, for example, a button or a microphone. A display unit 203 performs various kinds of display. The display unit 203 may be configured to output not only visual information but also audio information. Hence, the display unit 203 is configured as a display formed by a light emitting diode (LED) and the like, a speaker, or an arbitrary combination thereof. Note that like a display with a touch panel, the input unit 202 and the display unit 203 may be configured as a user interface (UI) by functioning together. An image capturing unit 204 performs image capturing and digitizes an image acquired by the image capturing, thereby generating image data. The image capturing unit 204 is formed by, for example, a camera or an image sensor. A wireless communication unit 205 wirelessly communicates with another communication apparatus based on the IEEE802.11 series standard. The wireless communication unit 205 may perform wireless communication based on another standard such as Bluetooth® or Near Field Communication (NFC). The wireless communication unit 205 is formed by, for example, a wireless communication module, a wireless communication integrated circuit, and an antenna.

The functional arrangement of the smartphone 100 will be described next. Referring to FIG. 2B, a transmission unit 210 and a reception unit 211 transmit/receive various kinds of frames (signals) via the wireless communication unit 205. An information analysis unit 212 analyzes Bootstrap information (to be described later) acquired via the image capturing unit 204 or the like. A display control unit 213 performs display control for the display unit 203. An authentication processing unit 214 performs authentication processing. A result determination unit 215 determines, based on information received by the reception unit 211, whether the result of an attempt of the printer 101 in participating in a wireless LAN formed by an access point indicates a success. A channel control unit 216 performs control for establishment and disconnection of a secure channel to/from the printer 101 via control for the transmission unit 210, the reception unit 211, and the storage unit 201.

(Arrangement of Printer 101)

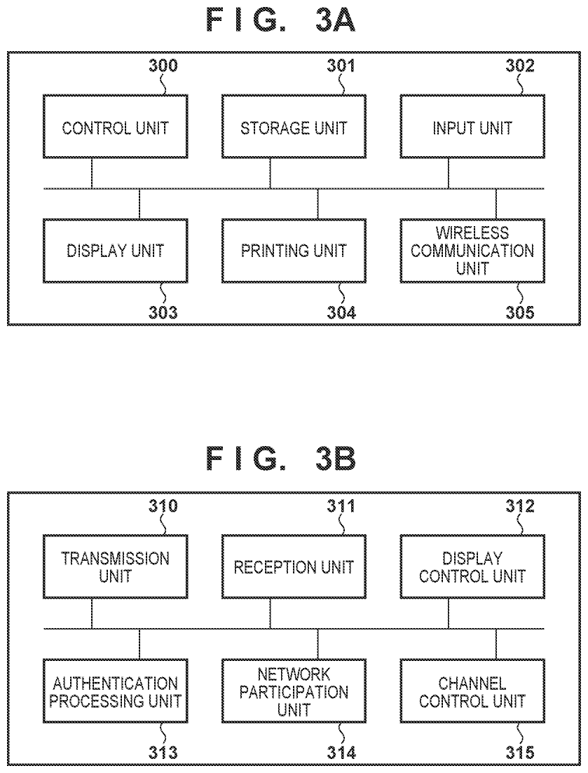

FIGS. 3A and 3B show the arrangement of the printer 101. FIG. 3A shows an example of the hardware arrangement of the printer 101, and FIG. 3B shows an example of the functional arrangement of the printer 101. The hardware arrangement of the printer 101 will be described first. Referring to FIG. 3A, a control unit 300, a storage unit 301, an input unit 302, a display unit 303, and a wireless communication unit 305 are the same as the control unit 200, the storage unit 201, the input unit 202, the display unit 203, and the wireless communication unit 205 of the smartphone 100 shown in FIG. 2A, and a description thereof will be omitted. A printing unit 304 has a function of converting digital information into a print image and printing it on a medium such a paper sheet using ink, toner, or the like.

The functional arrangement of the printer 101 will be described next. Referring to FIG. 3B, a transmission unit 310 and a reception unit 311 transmit/receive various kinds of frames (signals) via the wireless communication unit 305. A display control unit 312 performs display control for the display unit 303. An authentication processing unit 313 performs authentication processing. A network participation unit 314 attempts to participate in a network managed by a desired access point in accordance with a predetermined procedure. A channel control unit 315 performs control for establishment and disconnection of a secure channel to/from the smartphone 100 via control for the transmission unit 310, the reception unit 311, and the storage unit 301.

(Procedure of Processing)

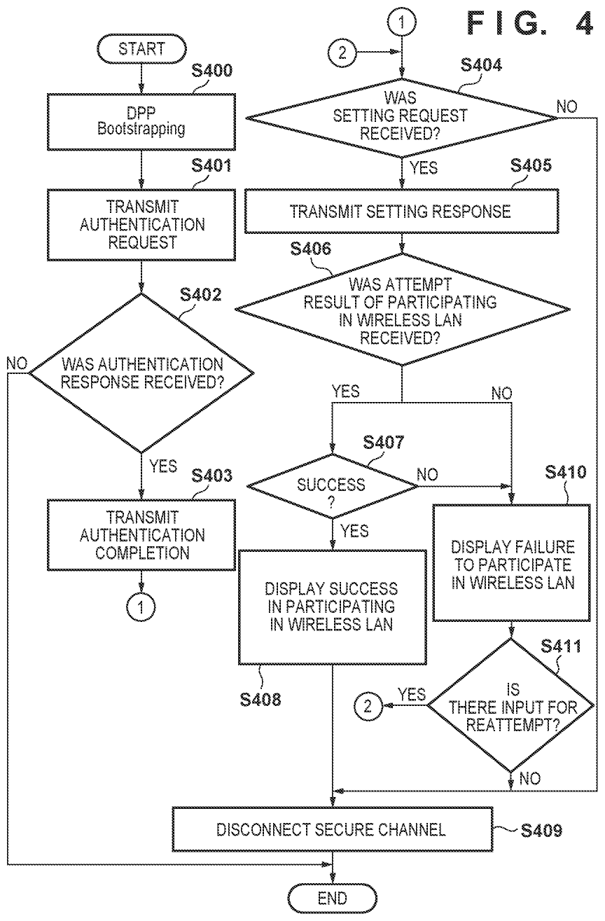

Processing between the smartphone 100 and the printer 101 according to this embodiment will be described next. Processing of the smartphone 100 will be described first. FIG. 4 is a flowchart of processing of the smartphone 100 according to this embodiment. The flowchart shown in FIG. 4 can be implemented when the control unit 200 of the smartphone 100 executes a control program stored in the storage unit 201, and executes calculation and processing of information and control of each piece of hardware. In addition, the processing of this flowchart is started when, for example, application software stored in the storage unit 201 and configured to connect the printer 101 to a wireless LAN is activated. Note that this application software can be activated when an activation instruction is input by the user to the input unit 202.

Note that the storage unit 201 of the smartphone 100 is assumed to store at least, in advance, a communication parameter used to participate in a wireless LAN formed by the access point 102. The communication parameter in this embodiment is information used to participate in a wireless LAN, such as a connector defined by the DPP standard. The communication parameter can be input in advance by the user via the input unit 202 or by another arbitrary means.

In step S40, the smartphone 100 executes DPP Bootstrapping and acquires Bootstrap information defined by the DPP. The Bootstrap information includes a public key and the like. Note that in this embodiment, a description will be made assuming that a quick response (QR) code is used for DPP Bootstrapping. However, another arbitrary image such as a two-dimensional code or a barcode may be used. As a detailed processing example of step S400, first, the display control unit 213 displays, on the display unit 203, a message that instructs to capture a QR code displayed on the display unit of the printer 101 that is made to participate in the wireless LAN. When the user inputs an image capturing instruction via the input unit 202 based on the message, the control unit 200 activates the image capturing unit 204, and the image capturing unit 204 thus captures the image of the QR code displayed on the printer 101. Next, the information analysis unit 212 acquires Bootstrap information from the captured image of the QR code and stores it in the storage unit 201. Note that in this embodiment, a QR code is used for DPP Bootstrapping, as described above. Another method defined by the DPP standard, such as Bluetooth or NFC may be used. That is, the smartphone 100 may acquire Bootstrap information by Bluetooth, NFC, or the like. Next, the information analysis unit 212 analyzes the acquired Bootstrap information, and transfers information included in the Bootstrap information to the transmission unit 210.

In step S401, the transmission unit 210 generates an authentication request frame (DPP authentication request frame) based on the information included in the Bootstrap information, and transmits it to the printer 101. After the transmission of the authentication request frame, in step S402, the reception unit 211 waits for reception of an authentication response frame (DPP authentication response frame) from the printer 101 for a predetermined time. The predetermined time is, for example, 5 sec. If the reception unit 211 receives the authentication response frame within the predetermined time (YES in step S402), the authentication processing unit 214 executes authentication processing. If authentication succeeds, the process advances to step S403. On the other hand, if the reception unit 211 does not receive the authentication response frame within the predetermined time (NO in step S402), the procedure is ended. Note that even when the authentication processing unit 214 has failed in the authentication processing, the procedure is ended.

In step S403, the transmission unit 210 generates an authentication completion frame (DPP authentication confirm frame) based on the authentication response frame received by the reception unit 211, and transmits it to the printer 101. According to the DPP standard, exchange of the authentication request frame, the authentication response frame, and the authentication completion frame is called a DPP authentication protocol. When the exchange of these frames is completed, a secure channel is established between the smartphone 100 and the printer 101. Note that in this embodiment, the exchange of these frames is controlled by the channel control unit 216. After the establishment of the secure channel, the channel control unit 216 stores information concerning the established secure channel in the storage unit 201 and manages it.

After the establishment of the secure channel, in step S404, the reception unit 211 waits for reception of a configuration request frame (DPP configuration request frame) from the printer 101 for a predetermined time. The predetermined time is, for example, 5 sec. If the reception unit 211 receives the configuration request frame within the predetermined time (YES in step S404), the process advances to step S405. If the configuration request frame is not received within the predetermined time (NO in step S404), the process advances to step S409.

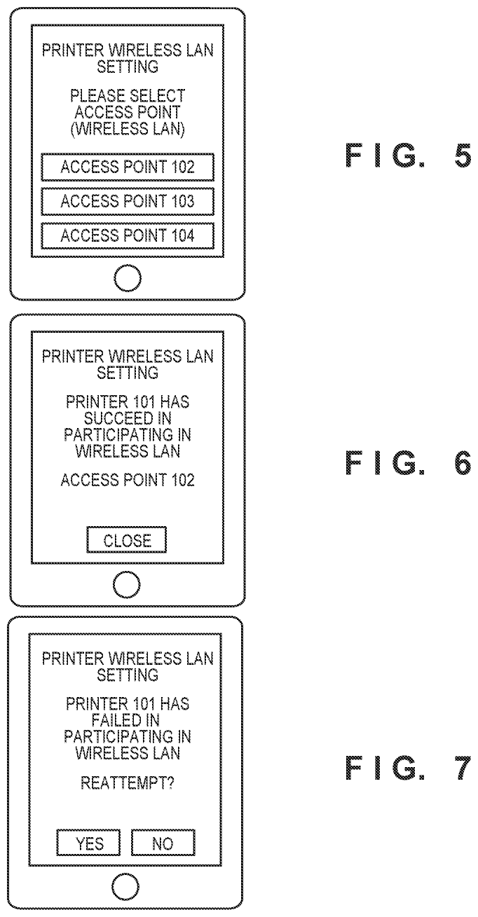

In step S405, the transmission unit 210 reads out the communication parameter stored in the storage unit 201, generates a configuration response frame (DPP configuration response frame) based on the communication parameter, and transmits it to the printer 101. Note that if a communication parameter corresponding to each of the plurality of access points is stored in the storage unit 201 of the smartphone 100, the smartphone 100 may be configured to cause the user to select one of the plurality of access points. For example, the display control unit 213 can display, on the display unit 203, identification information of each of the plurality of access points and a message that instructs the user to select one of them. The identification information includes, for example, the media access control (MAC) address of each access point, and the extended service set identifier (ESSID) of a wireless LAN managed by each access point. FIG. 5 shows an example of a screen configured to cause the user to select one arbitrary access point from a plurality of access points. In the example of the screen shown in FIG. 5, when the user inputs an instruction for selecting one arbitrary access point via the input unit 202, the processing of step S405 can be executed for the selected access point.

After the transmission of the configuration response frame, in step S406, the reception unit 211 waits for reception of the result (attempt result) of the attempt of the printer 101 in participating in the wireless LAN formed (managed) by the access point 102 (connecting to the access point 102) from the printer 101 for a predetermined time. The predetermined time is, for example, 5 sec. The attempt result may be transmitted by an action frame defined by the IEEE802.11 series standard, like a frame used in the DPP. Alternatively, the attempt result may be transmitted by a data frame or another frame. If the reception unit 211 receives the attempt result within the predetermined time (YES in step S406), the process advances to step S407. If the reception unit 211 does not receive the attempt result within the predetermined time (NO in step S406), the process advances to step S410.

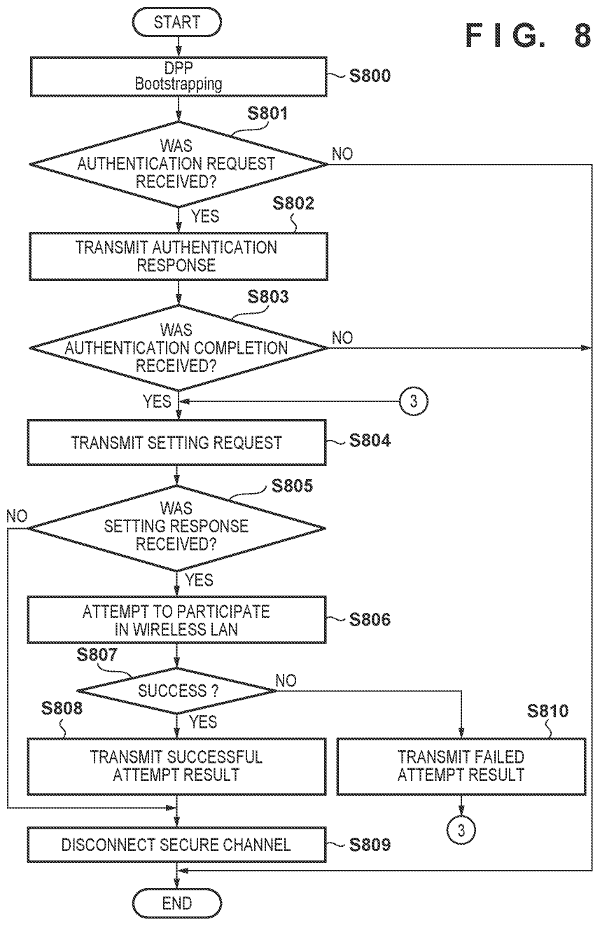

In step S407, the result determination unit 215 determines whether the trial result received by the reception unit 211 indicates a success. If the attempt result indicates a success (YES in step S407), the process advances to step S408. If the attempt result does not indicate a success (NO in step S407), the process advances to step S410. In step S408, the display control unit 213 displays, on the display unit 203, a message that notifies the user that the printer 101 has succeeded in participating in the wireless LAN formed by the access point 102. FIG. 6 is a view showing an example of a screen including a message that notifies a user that participation in the wireless LAN managed by the access point 102 has succeeded. After that, in step S409, the channel control unit 216 performs control for disconnecting the secure channel to/from the printer 101. For example, the channel control unit 216 deletes (invalidates) information concerning the secure channel, which is stored in the storage unit 201. This procedure is then ended. At this time, the channel control unit 216 may store a common key and the like and release the area on the storage unit 201 used to maintain the secure channel. Note that the disconnection processing is not limited to this. For example, the transmission unit 210 may transmit a disconnection frame (disassociation frame) defined by the IEEE802. II series standard to the printer 101 under the control of the channel control unit 216. Similarly, the transmission unit 210 may transmit an authentication cancel frame (deauthentication frame), or may transmit a disconnection notification included in an action frame, a data frame, or another frame. In addition, the reception unit 211 may wait for reception of these frames from the printer 101. If the reception unit 211 receives these frames, or a predetermined time (for example, 1 sec) elapses without reception, the smartphone 100 may perform the disconnection processing.

Note that when the secure channel is disconnected in step S409, a radio resource consumed by beacon frame transmission and the like can be reduced. It is therefore possible to increase the band usable for the communication between the printer 101 and the access point 102 or the band used by another device that uses the radio resource and achieve efficient use of the resource. It is also possible to reduce the resources of the smartphone 100 and the printer 101 used to maintain the secure channel. This can implement reduction of power consumption of the printer 101 and the access point 102 and improvement of performance for another processing such as communication between the printer 101 and the access point 102.

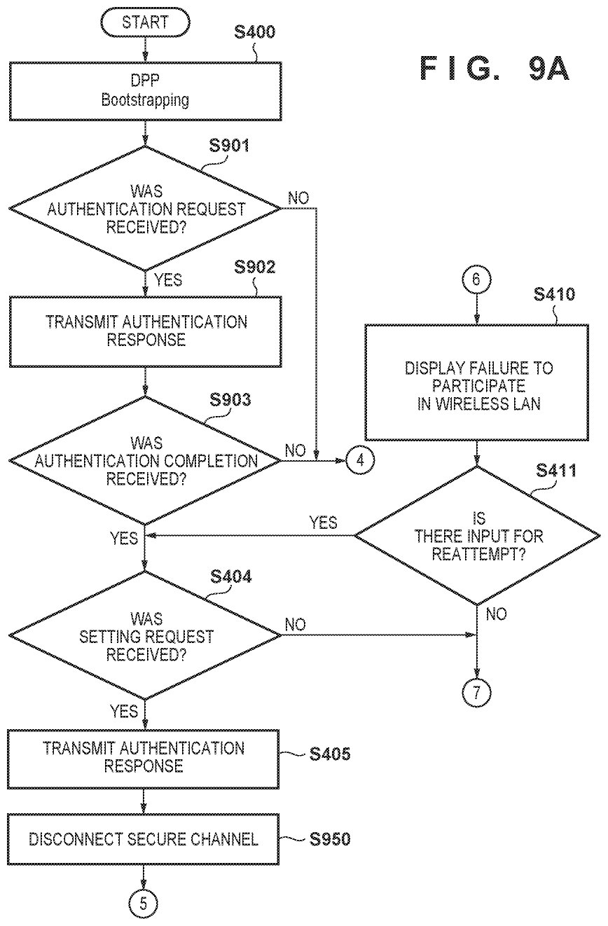

On the other hand, in step S410 to which the process advances if NO in step S406 or S407, the display control unit 213 displays, on the display unit 203, a message that notifies the user that the printer 101 has failed in participating in the wireless LAN formed by the access point 102. Also, the display control unit 213 may display, on the display unit 203, a message that asks the user whether to perform a reattempt. FIG. 7 shows an example of a screen including a message that notifies the user that the printer 101 has failed in participating in the wireless LAN formed by the access point 102. In the example of the screen, a message that asks the user whether to perform a reattempt is also displayed.

In step S411, the input unit 202 determines whether an input for instructing a reattempt is accepted from the user. In the example of the screen shown in FIG. 7, it is determined whether “YES” is input. If an input for instructing a reattempt is performed (YES in step S411), the process returns to step S404, and the reception unit 211 waits for reception of the configuration request frame from the printer 101 again for a predetermined time. If an input for instructing a reattempt is not performed (NO in step S411), the process advances to step S409. The processing of step S409 is as described above. After the processing of step S409, this procedure is ended. Note that in place of step S411, after the processing of step S410, the processing of steps S404 to S407 may be performed within a predetermined time.

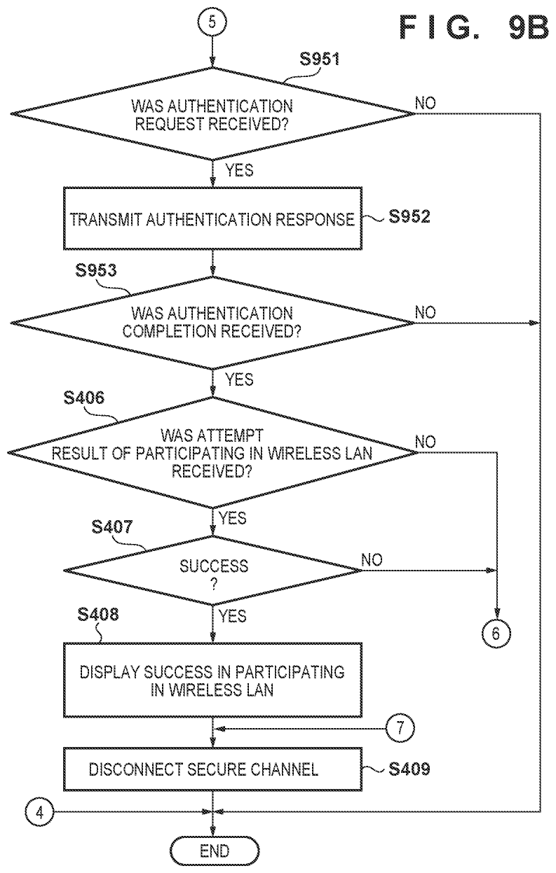

Processing of the printer 101 will be described next. FIG. 8 is a flowchart of processing of the printer 101 according to this embodiment. The flowchart shown in FIG. 8 can be implemented when the control unit 300 of the printer 101 executes a control program stored in the storage unit 301, and executes calculation and processing of information and control of each piece of hardware. In addition, the processing of this flowchart is started when, for example, application software stored in the storage unit 301 and configured to start setting of a wireless LAN by the DPP is activated in accordance with an instruction of the user.

In step S800, the printer 101 executes DPP Bootstrapping. Note that in this embodiment, a description will be made assuming that a QR code is used for DPP Bootstrapping, as described above. As a detailed processing example of step S800, the display control unit 312 displays, on the display unit 303, an image of a QR code including Bootstrap information stored in the storage unit 301. Note that in this embodiment, a QR code is used for DPP Bootstrapping. Another method defined by the DPP standard, such as Bluetooth or NFC may be used. That is, the printer 101 may provide Bootstrap information to the smartphone 100 by Bluetooth, NFC, or the like.

In step S801, the reception unit 311 waits for reception of an authentication request frame (DPP authentication request frame) from the smartphone 100 for a predetermined time. The predetermined time is, for example, 5 sec. If the reception unit 311 receives the authentication request frame within the predetermined time (YES in step S801), the authentication processing unit 313 executes authentication processing. If authentication succeeds, the process advances to step S812. On the other hand, if the reception unit 311 does not receive the authentication request frame within the predetermined time (NO in step S801), the procedure is ended. Note that even when the authentication processing unit 313 has failed in the authentication processing, the procedure is ended.

In step S802, the transmission unit 310 generates an authentication response frame (DPP authentication response frame) based on the authentication request frame received by the reception unit 311, and transmits it to the smartphone 100. After the transmission of the authentication response frame, in step S803, the reception unit 311 waits for reception of an authentication completion frame (DPP authentication confirm frame) from the smartphone 100 for a predetermined time. The predetermined time is, for example, 5 sec. If the reception unit 311 receives the authentication completion frame within the predetermined time (YES in step S803), a secure channel is established between the printer 101 and the smartphone 100. As described above, the secure channel establishing procedure is based on the DPP authentication protocol, and in this embodiment, exchange of the authentication request frame, the authentication response frame, and the authentication completion frame is controlled by the channel control unit 315. After the establishment of the secure channel, the channel control unit 315 stores information concerning the established secure channel in the storage unit 301 and manages it. On the other hand, if the reception unit 311 does not receive the authentication completion frame within the predetermined time (NO in step S803), the procedure is ended.

After the establishment of the secure channel, in step S804, the transmission unit 310 generates a configuration request frame (DPP configuration request frame) and transmits it to the smartphone 100. After the transmission of the configuration request frame, in step S805, the reception unit 311 waits for reception of a configuration response frame (DPP configuration response frame) from the smartphone 100 for a predetermined time. The predetermined time is, for example, 5 sec. Upon receiving the configuration response frame within the predetermined time (YES in step S805), the reception unit 311 stores a communication parameter included in the configuration response frame in the storage unit 301. Next, in step S806, the network participation unit 314 attempts to participate in a wireless LAN formed by the access point 102 that is a desired access point within a predetermined time using the communication parameter stored in the storage unit 301.

The attempt of participating in the wireless LAN is executed in accordance with, for example, a procedure defined by the DPP standard. That is, the network participation unit 314 performs discovery of an access point, transmission of a peer discovery request frame, and reception of a peer discovery response frame via the transmission unit 310 and the reception unit 311. Next to the transmission/reception of these frames, the network participation unit 314 performs a standard procedure defined by the IEEE802.11 series standard. The standard procedure defined by the IEEE802.11 series standard is configured in association with authentication. Note that 4-way handshake may be executed.

After the attempt of participating in the wireless LAN is performed for a predetermined time, in step S807, the network participation unit 314 determines whether the result of the participation attempt (attempt result) indicates a success. If the attempt result indicates a success (YES in step S807), the process advances to step S808. In step S808, the transmission unit 310 transmits, to the smartphone 100, a frame that notifies the user that the attempt result indicates a success. The attempt result can be transmitted by any frame, as described concerning the processing of step S406 in FIG. 4. When the transmission unit 310 transmits the frame that notifies the user that the attempt result indicates a success, the process advances to step S809.

In step S809, the channel control unit 315 performs control for disconnecting the secure channel to/from the smartphone 100. For example, the channel control unit 315 deletes (invalidates) information concerning the secure channel, which is stored in the storage unit 301. This procedure is then ended. At this time, the channel control unit 315 may store a common key and the like and release the area on the storage unit 301 used to maintain the secure channel. Note that the disconnection processing is not limited to this. For example, the transmission unit 310 may transmit a disconnection frame (disassociation frame) defined by the IEEE802.11 series standard to the smartphone 100 under the control of the channel control unit 315. Similarly, the transmission unit 310 may transmit an authentication cancel frame (deauthentication frame), or may transmit a disconnection notification included in an action frame, a data frame, or another frame. In addition, the reception unit 311 may wait for reception of these frames from the smartphone 100. If the reception unit 311 receives these frames, or a predetermined time (for example, 1 sec) elapses without reception, the printer 101 may perform the disconnection processing.

Note that when the secure channel is disconnected in step S809, a radio resource consumed by beacon frame transmission and the like can be reduced. It is therefore possible to increase the band usable for the communication between the printer 101 and the access point 102 or the band used by another device that uses the radio resource and achieve efficient use of the resource. It is also possible to reduce the resources of the smartphone 100 and the printer 101 used to maintain the secure channel. This can implement reduction of power consumption of the printer 101 and the access point 102 and improvement of performance for another processing such as communication between the printer 101 and the access point 102.

On the other hand, in step S810 to which the process advances if NO in step S807, the transmission unit 310 transmits, to the smartphone 100, a frame that notifies the user that the attempt result indicates a failure. The attempt result can be transmitted by any frame, as in step S808. When the transmission unit 310 transmits the attempt result, the process returns to step S804 to transmit the configuration request frame again. According to this, in step S805, the reception unit 311 can receive the configuration response frame from the smartphone 100 again. Hence, the printer 101 can quickly reattempt to participate in the wireless LAN using a different communication parameter (or the same communication parameter), and the convenience of the printer 101 can improve.

As described above, according to this embodiment, the printer 101 can quickly transmit, to the smartphone 100, the attempt result of participating in the wireless LAN formed by the access point 102, and the smartphone that has received this can perform display based on the notification. As a result, the convenience for the user improves. In addition, even during the attempt of the printer 101 in participating in the wireless LAN, the secure channel established by the DPP authentication protocol between the smartphone 100 and the printer 101 is maintained. Hence, the printer 101 can transmit the attempt result to the smartphone 100 by a more safe and reliable method.

### Second Embodiment

The second embodiment will be described next. Note that in this embodiment, points different from the first embodiment will be described.

(Procedure of Processing)

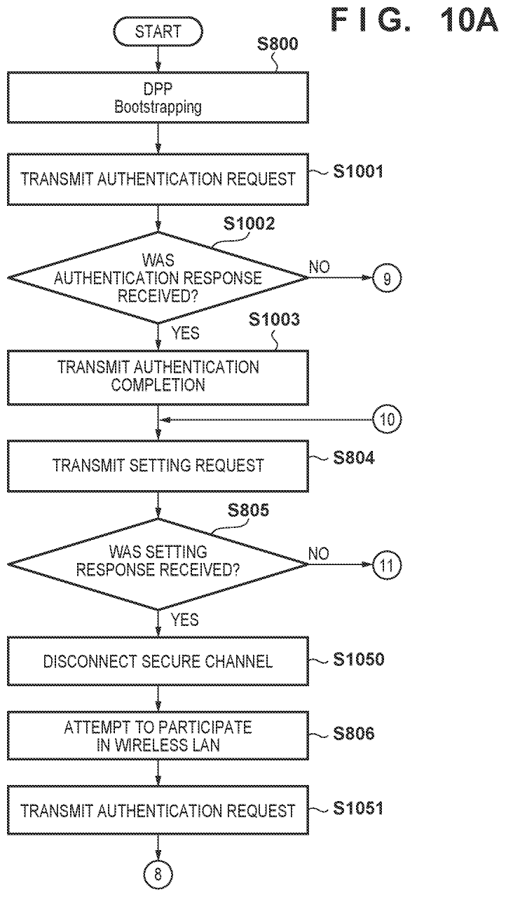

Processing between a smartphone 100 and a printer 101 according to this embodiment will be described. Processing of the smartphone 100 will be described first. FIGS. 9A and 9B are flowcharts of processing of the smartphone 100 according to this embodiment. The flowcharts shown in FIGS. 9A and 9B can be implemented when a control unit 20 of the smartphone 100 executes a control program stored in a storage unit 201, and executes calculation and processing of information and control of each piece of hardware. In addition, the processing of these flowcharts is started when, for example, application software stored in the storage unit 201 and configured to connect the printer 101 to a wireless LAN is activated. Note that this application software can be activated when an activation instruction is input by the user to an input unit 202.

In each step denoted by the same number as in FIG. 4, processing similar to the processing described with reference to FIG. 4 is executed. The process advances from step S400 to step S901 and from step S405 to step S950. In step S901, a reception unit 211 waits for reception of an authentication request frame (DPP authentication request frame) from the printer 101 for a predetermined time. The predetermined time is, for example, 5 sec. If the reception unit 211 receives the authentication request frame within the predetermined time (YES in step S901), an authentication processing unit 214 executes authentication processing. If authentication succeeds, the process advances to step S902. On the other hand, if the reception unit 211 does not receive the authentication request frame within the predetermined time (NO in step S901), the procedure is ended. Note that even when the authentication processing unit 214 has failed in the authentication processing, the procedure is ended.

In step S902, a transmission unit 210 generates an authentication response frame (DPP authentication response frame) based on the authentication request frame received by the reception unit 211, and transmits it to the printer 101. After the transmission of the authentication response frame, in step 903, the reception unit 211 waits for reception of an authentication completion frame (DPP authentication confirm frame) from the printer 101 for a predetermined time. The predetermined time is, for example, 5 sec. If the reception unit 211 receives the authentication completion frame within the predetermined time (YES in step S903), a secure channel is established between the printer 101 and the smartphone 100. After the establishment of the secure channel, a channel control unit 216 stores information concerning the established secure channel in the storage unit 201 and manages it. On the other hand, if the reception unit 211 does not receive the authentication completion frame within the predetermined time (NO in step S903), the procedure is ended.

After the establishment of the secure channel, processing similar to steps S404 and S405 shown in FIG. 4 is performed. Next, in step S950, the channel control unit 216 performs control for disconnecting the secure channel to/from the printer 101. The processing of this step is similar to the processing of step S409 in FIG. 4. Next, in steps S951, S952, and S953, processing similar to steps S901. S902, and S903 described above is executed. However, in step S953, if the reception unit 211 receives the authentication completion frame from the printer 101 (YES in step S953), a secure channel is established again, and the process advances to step S406. The subsequent processing is similar to a step of a corresponding number in FIG. 4.

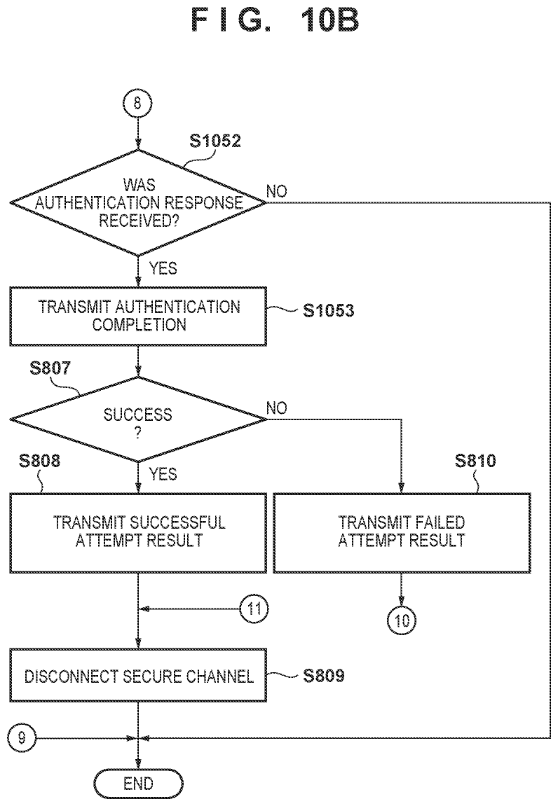

Processing of the printer 101 will be described next. FIGS. 10A and 10B are flowcharts of processing of the printer 101 according to this embodiment. The flowcharts shown in FIGS. 10A and 10B can be implemented when a control unit 300 of the printer 101 executes a control program stored in a storage unit 301, and executes calculation and processing of information and control of each piece of hardware. In addition, the processing of these flowcharts is started when, for example, application software stored in the storage unit 301 and configured to start setting of a wireless LAN by the DPP is activated in accordance with an instruction of the user.

In each step denoted by the same number as in FIG. 8, processing similar to the processing described with reference to FIG. 8 is executed. The process advances from step S800 to step S1001, from step S805 to step S1050, and from step S806 to step S1051. In step S1001, the transmission unit 310 generates an authentication request frame (DPP authentication request frame) based on information included in Bootstrap information stored in the storage unit 301, and transmits it to the smartphone 100. After the transmission of the authentication request frame, in step S1002, the reception unit 311 waits for reception of an authentication response frame (DPP authentication response frame) from the smartphone 100 for a predetermined time. The predetermined time is, for example, 5 sec. If the reception unit 211 receives the authentication response frame within the predetermined time (YES in step S1002), an authentication processing unit 313 executes authentication processing. If authentication succeeds, the process advances to step S1003. On the other hand, if the reception unit 211 does not receive the authentication response frame within the predetermined time (NO in step S1002), the procedure is ended. Note that even when the authentication processing unit 313 has failed in the authentication processing, the procedure is ended.

In step S1003, a transmission unit 310 creates an authentication completion frame (DPP authentication confirm frame) based on the authentication response frame received by the reception unit 311, and transmits it to the smartphone 100. A secure channel is thus established, and the channel control unit 315 stores information concerning the established secure channel in the storage unit 301 and manages it.

After the establishment of the secure channel, processing similar to steps S803 and S804 shown in FIG. 8 is performed. Next, in step S1050, a channel control unit 315 performs control for disconnecting the secure channel to/from the smartphone 100. The processing of this step is similar to the processing of step S809 in FIG. 8. Next, in steps S1051, S1052, and S1053, processing similar to steps S1001, S1002, and S1003 described above is executed, and a secure channel is established again. However, the process advances from step S1053 to step S807. The subsequent processing is similar to a step of a corresponding number in FIG. 8.

As described above, according to this embodiment, in addition to the effect described in the first embodiment, the secure channel is not unnecessarily maintained, thereby further reducing consumption of the radio resource and increasing the resource (band) usable as the system. It is therefore possible to implement further reduction of power consumption of the printer 101 and an access point 102 and further improvement of performance for another processing such as communication between the printer 101 and the access point 102.

according to the above embodiments, it is possible to notify the apparatus on the communication parameter providing side of the situation of an attempt in participating in the network by the apparatus on the communication parameter receiving side, thereby improving user convenience.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus functioning as an enrollee defined by a Device Provisioning Protocol (DPP) standard, the apparatus comprising:
a request unit configured to request a communication parameter to be used by the communication apparatus to participate in a network formed by an access point from another communication apparatus functioning as a configurator defined by the DPP standard;
a reception unit configured to receive the communication parameter from the other communication apparatus in response to the request;
a participation unit configured to attempt to participate in the network using the communication parameter; and
a transmission unit configured to transmit an attempt result of the participation in the network by the participation unit to the other communication apparatus.

2. The communication apparatus according to claim 1, wherein
in a case where the attempt result indicates a success, the transmission unit transmits the attempt result indicating the success to the other communication apparatus, and
in a case where the attempt result indicates a failure, the transmission unit transmits the attempt result indicating the failure to the other communication apparatus.

3. The communication apparatus according to claim 1, further comprising a channel control unit configured to perform control for establishing a secure channel based on the DPP standard to/from the other communication apparatus,
wherein the transmission unit transmits the attempt result to the other communication apparatus via the secure channel.

4. The communication apparatus according to claim 3, wherein in a case where the attempt result indicating a success is transmitted by the transmission unit to the other communication apparatus via the secure channel, the channel control unit performs control for disconnecting the secure channel.

5. The communication apparatus according to claim 3, wherein in a case where the attempt result indicating a failure is transmitted by the transmission unit to the other communication apparatus via the secure channel, the request unit requests the communication parameter from the other communication apparatus, and in a case where the reception unit receives the communication parameter in response to the request, the participation unit performs a reattempt to participate in the network using the communication parameter.

6. The communication apparatus according to claim 3, wherein the channel control unit performs the control for establishing the secure channel before the request by the request unit, and maintains the secure channel during an attempt of the participation in the network.

7. The communication apparatus according to claim 3, wherein the channel control unit performs the control for establishing the secure channel before the request by the request unit, in a case where the reception unit receives the communication parameter, performs the control for disconnecting the secure channel, and after the participation unit attempts to participate in the network, establishes the secure channel again.

8. A communication apparatus functioning as a configurator defined by a Device Provisioning Protocol (DPP) standard, the apparatus comprising:
a transmission unit configured to transmit, in response to a request, from another communication apparatus functioning as an enrollee defined by the DPP standard, for a communication parameter to be used by the other communication apparatus to participate in a network formed by an access point, the communication parameter to the other communication apparatus; and
a reception unit configured to receive, from the other communication apparatus, an attempt result of the participation in the network by the other communication apparatus using the communication parameter.

9. The communication apparatus according to claim 8, further comprising a channel control unit configured to perform control for establishing a secure channel based on the DPP standard to/from the other communication apparatus,
wherein the reception unit receives the attempt result from the other communication apparatus via the secure channel.

10. The communication apparatus according to claim 9, wherein in a case where the attempt result indicating a success is received by the reception unit from the other communication apparatus via the secure channel, the channel control unit performs control for disconnecting the secure channel.

11. The communication apparatus according to claim 9, wherein in a case where the attempt result indicating a failure is received by the reception unit from the other communication apparatus via the secure channel, the transmission unit transmits the communication parameter again to the other communication apparatus in response to the request for the communication parameter from the other communication apparatus.

12. The communication apparatus according to claim 9, wherein the channel control unit performs the control for establishing the secure channel before the communication parameter is transmitted by the transmission unit, and maintains the secure channel until the attempt result is received by the reception unit.

13. The communication apparatus according to claim 9, wherein the channel control unit performs the control for disconnecting the secure channel when the communication parameter is transmitted by the transmission unit, and establishes the secure channel again in a case where the reception unit receives a predetermined signal used to establish the secure channel from the other communication apparatus.

14. The communication apparatus according to claim 8, further comprising a display control unit for displaying the attempt result on a display unit.

15. A control method of a communication apparatus functioning as an enrollee defined by a Device Provisioning Protocol (DPP) standard, the method comprising:
requesting a communication parameter to be used by the communication apparatus to participate in a network formed by an access point from another communication apparatus functioning as a configurator defined by the DPP standard;
receiving the communication parameter from the other communication apparatus in response to the request;
attempting to participate in the network using the communication parameter; and
transmitting an attempt result of the participation in the network to the other communication apparatus.

16. A control method of a communication apparatus functioning as a configurator defined by a Device Provisioning Protocol (DPP) standard, the method comprising:
transmitting, in response to a request, from another communication apparatus functioning as an enrollee defined by the DPP standard, for a communication parameter to be used by the other communication apparatus to participate in a network formed by an access point, the communication parameter to the other communication apparatus; and
receiving, from the other communication apparatus, an attempt result of the participation in the network by the other communication apparatus using the communication parameter.

17. A non-transitory computer-readable storage medium storing a computer program for causing a computer to execute a control method of a communication apparatus functioning as an enrollee defined by a Device Provisioning Protocol (DPP) standard, the method comprising:
requesting a communication parameter to be used by the communication apparatus to participate in a network formed by an access point from another communication apparatus functioning as a configurator defined by the DPP standard;
receiving the communication parameter from the other communication apparatus in response to the request;
attempting to participate in the network using the communication parameter; and
transmitting an attempt result of the participation in the network to the other communication apparatus.

18. A non-transitory computer-readable storage medium storing a computer program for causing a computer to execute a control method of a communication apparatus functioning as a configurator defined by a Device Provisioning Protocol (DPP) standard, the method comprising:
transmitting, in response to a request, from another communication apparatus functioning as an enrollee defined by the DPP standard, for a communication parameter to be used by the other communication apparatus to participate in a network formed by an access point, the communication parameter to the other communication apparatus; and
receiving, from the other communication apparatus, an attempt result of the participation in the network by the other communication apparatus using the communication parameter.
